(19) United States
(12) Patent Application Publication
(10) Pub. No.: US 2023/0284627 A1
(43) Pub. Date: Sep. 14, 2023

(54) ANTIMICROBIAL COMPOSITIONS AND METHODS OF USE AND FOR MAKING SAME

(71) Applicant: MIG USA, LLC, High Point, NC (US)

(72) Inventors: Adnan Mjalli, High Point, NC (US); Bill Hitchcock, High Point, NC (US)

(21) Appl. No.: 17/927,240

(22) PCT Filed: May 21, 2021
(86) PCT No.: PCT/US2021/033660

§ 371 Date: Nov. 22, 2022

Related U.S. Application Data
(60) Provisional application No. 63/029,106, filed on May 22, 2020.

(51) Int. Cl. A01N 55/02; A01N 25/04; A01N 59/16

(52) U.S. Cl. CPC A01N 55/02; A01N 25/04; A01N 59/16

(57) ABSTRACT

Disclosed are compositions and methods for inhibiting, preventing, or eliminating the growth of microorganisms. In certain embodiments, the disclosed compositions and methods have antimicrobial activity. In some embodiments, an antimicrobial composition comprises silver particles. Also disclosed are methods of making and using such compositions.

### RELATED APPLICATIONS

This application claims priority to U.S. provisional patent application No. 63/029,106 filed on May 22, 2020. The disclosure of U.S. provisional patent application No. 63/029,106, is incorporated by reference in its entirety herein.

### FIELD OF THE INVENTION

The present disclosure relates to compositions, methods for producing compositions, and methods of using compositions. In embodiments, the compositions comprise an antimicrobial agent and kill microorganisms or inhibit the growth of microorganisms.

### BACKGROUND

It is often advantageous and/or desirable to reduce microorganism on a surface, on a human, and in the environment generally. For example, reducing microorganisms can reduce the likelihood a human's immune system becomes compromised resulting in illness and/or allergic reaction from contacting microorganisms in an environment.

Additionally, an increasing number of pathogenic microorganisms have developed resistance to currently available antimicrobial agents. Thus, there is a need for new antimicrobial agents with active ingredients to which these microorganisms are susceptible. Silver has been demonstrated to have antimicrobial properties.

### SUMMARY OF THE DISCLOSURE

The present disclosure provides compositions and methods for inhibiting, preventing, or eliminating the growth of microorganisms. In certain embodiments, the disclosed compositions and methods have antimicrobial activity. In some embodiments, an antimicrobial composition comprises silver particles. The present disclosure also provides methods for reducing or inhibiting microorganisms on a surface, comprising contacting the surface with any of the compositions described herein. Also disclosed are methods for making such anti-microbial compositions.

### BRIEF DESCRIPTION OF THE FIGURES

The disclosure may be better understood by referencing the following non-limiting figures.

FIG. 1 shows the base formulation of a silver 1-methyl imidazole complex 635 (AM365) in accordance with an embodiment of the disclosure. The arrow in FIG. 1 indicates off-gassing of nitrate gas.

FIG. 2 illustrates how AM635 may be packaged in accordance with an embodiment of the disclosure.

### DETAILED DESCRIPTION

The presently disclosed subject matter now will be described more fully hereinafter with reference to the accompanying description, in which some, but not all embodiments of the presently disclosed subject matter are shown. The disclosed subject matter can be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the disclosed subject matter set forth herein will come to mind to one skilled in the art to which the disclosed subject matter pertains having the benefit of the teachings presented in the description. Therefore, it is to be understood that the disclosed subject matter is not to be limited to the specific embodiments disclosed herein and that modifications and other embodiments are intended to be included within the scope of the appended claims. Although specific terms are employed herein, they are used in a generic and descriptive sense only and not for purposes of limitation.

### Definitions

While the following terms are believed to be well understood by one of ordinary skill in the art, the following definitions are set forth to facilitate explanation of the presently disclosed subject matter. Other definitions are found throughout the specification. Unless otherwise defined, all technical and scientific terms used herein have the same meaning as commonly understood by one of ordinary skill in the art to which this presently described subject matter belongs.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

The terms “a”, “an”, and “the” refer to “one or more” when used in this application, including the claims. Thus, for example, reference to “a cell” includes a plurality of such cells, unless the context clearly is to the contrary (e.g., a plurality of cells), and so forth.

The term “or” ”is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “about” is used to indicate that a value includes the inherent variation of error for the device, the method being employed to determine the value, or the variation that exists among sample.

The term “bioadhesive” refers to natural polymeric materials that act as adhesives.

The term “buffer solution” is used to indicate a solution that resists a change in pH hen hydrogen ions (H⁺) or hydroxide ions (OH⁻) are added. A buffered solution may be produced by mixing a weak acid with its conjugate base. The buffer solution may be added to water to create “buffered water.”

The term “gelling catalyst” is used to refer to any substance that increase the rate of reaction of converting a sol into a gel (i.e., gelling).

The term “gel” is used to refer to a sol in which the solid particles are meshed such that a rigid or semi-rigid mixture results.

The term “microorganisms” as used herein includes the major groups of microorganisms such as bacteria, fungi (e.g., yeasts and molds), algae, and protozoa. While not living organisms, viruses are generally classified as microorganisms. Thus, microorganisms as described herein may include, but are not limited to bacteria, fungi, viruses, algae, protozoa, or any other microorganisms. Many microorganisms are pathogenic and are responsible for causing infectious diseases.

The term “solvent” is used to refer to any substance, typically a liquid, in which other substances dissolve.

### Antimicrobial Composition

In one aspect, provided herein is an antimicrobial composition comprising silver particles. Silver is a well-known bactericidal agent, but its uses are limited in part due to its short active chemical lifespan

As described herein, compositions comprising silver may be effective as antimicrobial compositions. In some embodiments, the composition comprises at least one silver particle. In some embodiments, the silver particle may be a silver nanoparticle, silver salt, silver oxide, or elemental silver. Non-limiting examples of silver salts include silver lactate, silver sulfate, silver nitrate, silver phosphate, silver chloride, silver iodide, silver perchlorate hydrate, silver carbonate, silver bromide, silver diethyldithiocarbamate, and silver citrate. In other embodiments, the composition comprises silver metallic powder. In some embodiments, the silver may be present in the composition in an amount ranging from about 0.5 to 10 wt. %. In some embodiments, the silver is present in 0.5, 1, 2, 5, or 10 wt. %.

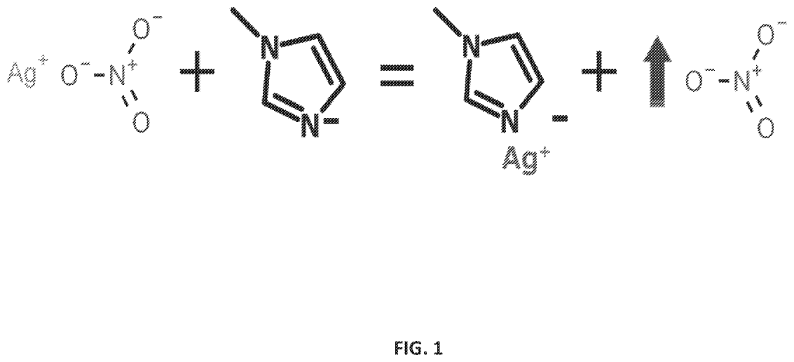

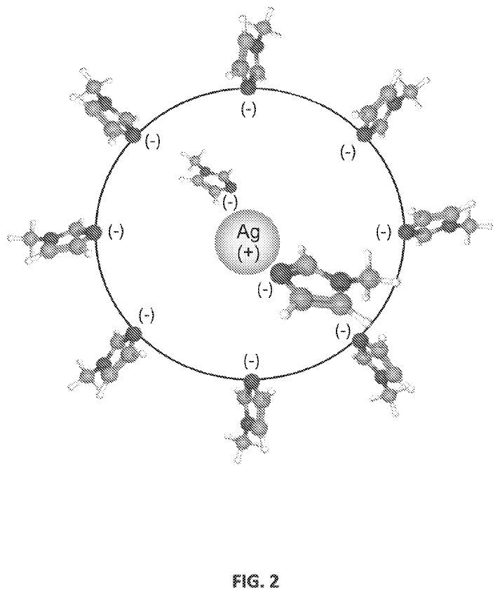

In some embodiments, the composition further comprises methylimidazole. In some embodiments, the methylimidazole is 1-methylimidazole or 2-methylimidazole. In certain instances, silver particles are combined with 1-methylimidazole to form a more stable silver complex and increase the antimicrobial properties of the composition. In certain embodiments, the increased stability is due in part to the ionic bond formed between silver particles and 1-methylimidazole. In some embodiments, the silver composition is Silver 1-Methyl imidazole Complex 635 (AM635). The base formulation of AM635 is shown in FIG. 1. The composition of Silver 1-Methyl imidazole Complex 635 is such that it is able to overcome the limitations of silver, including its short active chemical lifespan. AM635 is able to package silver ions in a form that allows for extended shelf life, application stability, and expanded antimicrobial properties. FIG. 2 illustrates an embodiment of how AM635 may be packaged. FIG. 2 illustrates a 1:10 molar ratio of one silver atom to ten 1-methyl imidazole molecules with the 1-methyl imidazole molecules complexing around the hard-positive charge of the silver ion. The bonding of silver to 1-methylimidazole can allow for improved formulation stability, allowing it to be a more effective antibacterial agent.

In some embodiments, the composition further comprises at least one additional component. As used herein, in some embodiments this additional component is a carrier. In some embodiments, the additional component or carrier optionally comprises at least one of: alcohol, water, acid (e.g., lactic acid or acetic acid), polypropylene, glycerol, chitosan, glycerine, tetrasodium ethylenediaminetetraacetic acid (EDTA), fragrance, chamomile, aloe vera, or any combination thereof. In certain instances the one or more additional components improve the solubility, durability, stability, or other properties of the composition. In some instances the additional component has further antimicrobial properties. For example, aloe vera comprises polyphenol antioxidants. Polyphenols and other compounds present in aloe vera may inhibit the growth of certain pathogenic bacteria. In other instances, the additional component has antimicrobial and healing properties. For example, chamomile has antibacterial antifungal, antiviral, anti-inflammatory properties.

The composition may be formulated in a variety of formats. In alternative embodiments, the composition is formulated as a liquid, an aerosol, a powder, a cream, a gel, or a lotion. The composition may be formulated using guidelines and methods standard in the field of pharmaceuticals and/or antimicrobial agents. In some embodiments, the composition may be an antiseptic, sanitizer, or disinfectant. For example, the composition may be formulated as a hand sanitizer, body lotion, mouthwash, detergent, household cleaner, coating, ointment, or any other formulation where it would be desirable to have antimicrobial properties. In some embodiments, the formulation may be applied to a variety of materials, including but not limited to bandages, wound dressing, medical devices, wipes, or cloth.

In some embodiments, the carrier gel for the active ingredients comprises chitosan. Chitosan has been demonstrated to have several uses including as an anti-cancer agent, a wound healing agent, and an antimicrobial agent. Alsarra (2009) International Journal of Biological Macromolecules 45: 6-21. Chitosan-based gels are ideal carriers for topically delivering therapeutic agents due to their low toxicity, biocompatibility, and non-immunogenic properties.

Chitosan is a deacetylated derivative of chitin that is made by treating the chitin found in the shells of shellfish with an alkaline substance. Chitosans are understood to be a family of binary heteropolysaccharides composed of β-1→4 linked 2-acetamido-2-deoxy-β-d-glucopyranose (GlcNAc, the “acetylated”, i.e., the A unit) and 2-amino-2-deoxy-β-d-glucopyranose (GlcNH₂, the “deacetylated”, i.e., the D unit) residues, present in different relative proportion and sequence along the chain. Sacco et al. (2018) Gels 4(3):67. The degree of deacetylation of chitosan provides the molar percentage of glucosamine monomeric units and varies from 0 (chitin) to 100 (fully deacetylated chitin). The amount of deacetylation affects the ability of chitosan to undergo the transition to a gel as well as the overall stability of the gel. In certain instances, the carrier gel comprises chitosan. In some embodiments, the chitosan gel is made using deacetylated chitosan powder. In some embodiments, the chitosan powder is at least 85%, at least 90% or at least 95% deacetylated. In some embodiments the composition comprises from about 0.5% to 5% by weight of chitosan powder.

In further embodiments, the carrier comprises water or buffered water. In an embodiment, the chitosan is dispersed in water prior to the addition of a gelling catalyst. The addition of water allows the chitosan to crosslink polymer chains upon addition of a gelling catalyst. In some embodiments, the composition comprises from 25-50% water.

Gelling of chitosan powder can be accomplished by chemical or physical means. Thus, in some embodiments the carrier further comprises a gelling catalyst. However, several known methods for gelling chitosan powder are toxic and are not suitable for biomedical uses. In certain embodiments, the gelling catalyst is non-toxic and is suitable for biomedical uses. In some instances, the gelling catalyst is a weak acid, for example, a sugar acid. Sugar acids are monosaccharides with a carboxyl group at one or both ends of its chain. Gelling catalysts suitable for gelling chitosan powder include, but are not limited to lactic acid, acetic acid, and glycolic acid. In some embodiments, the composition comprises from about 0.5% to 5% by weight of the gelling catalyst.

In some embodiments, the carrier further comprises one or more solvents. In certain embodiments, the solvent is a non-aqueous solvent. In some instances, the solvent is also a humectant, or a substance with the ability to draw moisture from the surrounding environment. In some instances, the solvent will also function as a gel plasticizing agent, transdermal vehicle, and moisturizing agent. In some embodiments, the solvent is glycerol. In other embodiments, the solvent is propylene glycol, butylene glycol, or sorbitol. In some embodiments, the composition comprises from about 0.5% to 5% by weight of the solvent.

In some embodiments, the composition is prepared by combining a silver composition with a previously prepared carrier composition. For example, in some embodiments, the Silver 1-Methyl imidazole Complex (AM635) solution is combined directly with a chitosan-based gel composition. In some embodiments, the chitosan-based gel composition is a 2% chitosan gel. In some embodiments, the AM635 solution is combined with the 2% chitosan gel to achieve a 1% w/w of AM635. Or, other ratios of siliver composition to carrier may be used.

In some embodiments, the AM635 solution is first combined with DMSO prior to combination with a carrier. DMSO may increase the stability of the silver particles in the final solution.

Silver is known to have upwards of 20 modes of lethality to bacteria and therefore the ability of bacterial to develop resistance to silver compositions is unlikely. In certain embodiments, the compositions described herein have broad spectrum bactericidal properties (i.e., capable of killing bacteria). Thus, in some instances the compositions are effective in killing Gram-positive and/or Gram-negative bacterial strains. In some embodiments, the compositions have bactericidal properties against antibiotic resistant bacteria. One such example is methicillin resistant Staphylococcus aureus (MRSA). Non-limiting examples of bacteria capable of being killed by the methods described herein include Staphylococcus spp., Salmonella spp., Streptococcus spp., Listeria monocytogenes, Eschericia coli, and Vibrio spp.

Silver is not known to have antiviral properties. In some embodiments, the compositions described herein are formulated such that they exhibit antiviral properties. Thus, in some embodiments, the compositions described herein are viricidal agents. Thus, in some instances the compositions are effective in killing viruses. In some embodiments, the compositions described herein are capable of killing both positively and negatively charged viral shells. Non-limiting examples of viruses capable of being killed by the compositions described herein include, but are not limited to Influenza, Herpes simplex, Coronavirus (e.g., COVID-19), Norovirus, Rhinovirus, and Rotavirus. In certain instances, the compositions described herein are effective against human papillomavirus (HPV).

In some embodiments, the compositions described herein are fungicidal agents. Non-limiting examples of fungi capable of being killed by the mecompositionsthods described herein include, but are not limited to Candida spp., Blastomyces, ringworm, Cryptococcus gattii, Paracoccidioides, Aspergillus, and Coccidioides.

In some embodiments, the compositions described herein are algicidal agents. Non-limiting examples of algae capable of being killed by the compositions described herein include, but are not limited to Protothecosis.

In some embodiments, the compositions described herein are protozoacides. Non-limiting examples of protozoa capable of being killed by the compositions described herein include, but are not limited to Leishmania spp., Trypanosoma spp., and Plasmodium spp.

In some embodiments, the composition is a disinfectant spray or aerosol. For example, AM635 can be functionalized into a stable and effective disinfectant spray/aerosol. In some embodiments, the aerosol composition further comprises a stabilizing agent. For example, surfactants and/or detergents can be used to enhance the wettability of the composition without interfering with antimicrobial efficacy. In some embodiments, the AM635 solution is added to a disodium tetraborate decahydrate (borax) base solution. In another embodiments, the AM635 solution is added to a sodium dodecyl sulfate (SDS) base solution.

In another aspect of the disclosure, provided is an article of manufacture comprising a composition, wherein the composition comprises silver particles. In some embodiments, the composition may comprise between 0.5 and 10 wt. % silver particles. In some embodiments, the composition may further comprise 1-methylimidazole. In some instances, the article of manufacturer comprises any of the compositions described herein.

Also disclosed are methods of making such compositions. In an embodiment, the method of making an antimicrobial composition comprise combining silver particles with at least one carrier. For example, the carrier may comprise at least one of an alcohol, water, acid (e.g., lactic acid or acetic acid), polypropylene, glycerol, chitosan, glycerine, tetrasodium ethylenediaminetetraacetic acid (EDTA), fragrance, chamomile, aloe vera, or any combination thereof. In some embodiments, the silver particle is a silver salt. For example, the silver salt may be a silver nitrate. The silver may be added such that it is at an effective concentration to function as an antimicrobial agent. In some embodiments, the amount of silver is between 0.5 to 10 wt. %. Also, in some embodiments, the method of making may comprise adding 1-methylimidazole.

Methods of Use

In another aspect of the disclosure, provided is a method of using any of the compositions described herein to disinfect or sanitize a surface. In some embodiments, the compositions may be used to inhibit or prevent the growth of microorganisms. In some embodiments, the surface is part of a living organism. For example, the living organism may be a human, and the composition may be applied to the skin, teeth, nails, hair, or mouth. In some embodiments, the compositions is applied to an open wound to aid in healing and the prevention of infection. In other embodiments, the surface is an inanimate object. For example, the inanimate object may comprise countertops, household objects, floors, medical devices, medical equipment, laboratory equipment, clothing, or bandages. In other embodiments, the compositions described herein may be applied to the air. In an embodiment, the composition may be applied as a bioadhesive.

In some embodiments, the compositions and methods described herein are effective in preventing and/or inhibiting the growth of microorganisms. Silver possesses several antimicrobial properties, including broad-spectrum antibiotic, and is known to suppress and kill microorganisms. Additionally, silver has low toxicity to human cells when used at levels toxic to microorganisms.

Over time, a variety of pathogenic microorganisms have developed mechanisms that have allowed them to become resistant to antimicrobial agents. For example, some pathogenic bacteria (e.g., methicillin-resistant Staphylococcus aureus (MRSA)) have developed resistance to antibiotics. Thus, the development of new antimicrobial agents is vital in preventing and/or limiting the spread of infectious diseases, such as common cold, flu, gastroenteritis, meningitis, conjunctivitis, pneumonia, cellulitis, impetigo, urinary tract infections, cold sores, ringworm, measles, mumps, rubella, mononucleosis, chicken pox, boils, athlete's foot, and yeast infections.

Infectious diseases are caused by pathogenic microorganisms. Thus, it is advantageous to reduce the number of pathogenic microorganisms and/or prevent pathogenic microorganisms from growing. The compositions and methods of the present disclosure may be helpful in inhibiting and/or eliminating microorganisms.

In some embodiments, the methods described herein are used to eliminate or reduce the number of bacteria on a surface. Non-limiting examples of bacteria capable of being killed by the methods described herein include Staphylococcus spp., Salmonella spp., Streptococcus spp., Listeria monocytogenes, Eschericia coli, and Vibrio spp.

In some embodiments, the methods described herein are used to eliminate or reduce the number of viruses on a surface. Non-limiting examples of viruses capable of being killed by the methods described herein include, but are not limited to Influenza, Herpes simplex, Coronavirus (e.g., COVID-19), Norovirus, Rhinovirus, and Rotavirus.

In some embodiments, the methods described herein are used to eliminate or reduce the number of fungi on a surface. Non-limiting examples of fungi capable of being killed by the methods described herein include, but are not limited to Candida spp., Blastomyces, ringworm, Cryptococcus gattii, Paracoccidioides, Aspergillus, and Coccidioides.

In some embodiments, the methods described herein are used to eliminate or reduce the number of algae on a surface. Non-limiting examples of algae capable of being killed by the methods described herein include, but are not limited to Protothecosis.

In some embodiments, the methods described herein are used to eliminate or reduce the number of protozoa on a surface. Non-limiting examples of protozoa capable of being killed by the methods described herein include, but are not limited to Leishmania spp., Trypanosoma spp., and Plasmodium spp.

In some embodiments of the methods, the composition is applied to the surface by spraying, soaking, rubbing, swabbing, squirting, dropping, or any other method known in the art for applying gels, lotions, creams, liquids, powders, or aerosols.

In some embodiments, the methods are used to treat an active infection. Treatment sites capable of being treated with the compositions and method described herein include sites of infection, injury or burn. Treatment sites include skin and mucosal surfaces. For example, the compositions described herein may be used to treat a cold sore resulting from an infection caused by herpes simplex virus. For example, a topical gel composition comprising silver 1-methyl imidazole may be applied directly to the cold sore when the prodromal symptoms for the viral outbreak occur, as soon as the lesion can be felt at the nerve endings (tingle) prior to the exit portal lesion being formed. Treatment at this point in the viral cycle keeps the virus from replicating. In some embodiments, the composition is applied to a treatment site at least 1, 2, 3, 4, 5, 6, 7, or 8 times a day. for at least 1, 2, 3, 4, 5, 6, 7, 8, 9, 10, 11, 12, 13, or 14 days in a row. In some embodiments, treatment with the compositions described herein shortens the cold sore cycle by at least 1, 2, 3, 4, 5, 6, 7, 8, 9, or 10 more days. Thus, in some embodiments, the methods are used to decrease the time of active infection.

In other embodiments, the compositions described herein are used to promote wound healing. For example, the compositions may be used to treat wounds resulting from injury, burns, disease, or medical conditions. For example, the compositions described herein may be applied directly to an open wound to prevent infection and assist in healing. In some embodiments, the composition is applied to a treatment site at least 1, 2, 3, 4, 5, 6, 7, or 8 times a day for at least 1, 2, 3, 4, 5, 6, 7, 8, 9, 10, 11, 12, 13, or 14 days in a row. In some embodiments, treatment with the compositions described herein shortens the healing time by at least 1, 2, 3, 4, 5, 6, 7, 8, 9, or 10 more days. Thus, in some embodiments, the methods are used to decrease the total healing time of a wound.

### EXAMPLES

The following examples have been included to provide guidance to one of ordinary skill in the art for practicing representative embodiments of the presently disclosed subject matter. In light of the present disclosure and the general level of skill in the art, those of skill can appreciate that the following examples are intended to be exemplary only and that numerous changes, modifications, and alterations can be employed without departing from the scope of the presently disclosed subject matter.

The following examples describe methods for the preparations and use of a silver particle composition.

### Example 1. Preparation of Silver 1-Methyl imidazole Complex 635

Materials

The following materials were used in the examples and methods below:
1. 1-Methyl imidazole, CAS #616-47-7
2. Silver Nitrate, CAS #7761-88-8

6.35 g of 1-methyl imidazole was added to a beaker on a stir plate and stirred using a magnetic stir bar at a medium speed. 1 g of silver nitrate particles were added to the 1-methyl imidazole and stirred until the solution turns a slightly gold tinted clear liquid. The base formulation is shown in FIG. 1. A proposed model arrangement of Silver 1-Methylimidazole Complex 635 is shown in FIG. 2. For a 1:10 molar ratio of 1 silver atom for 10 1-methyl imidazole atoms, a circular arrangement of the weak negative charges of the 1-methyl imidazole atoms complexing around the hard-positive charge of the silver atom would be expected.

### Example 2. Preparation of Silver 1-Methylimidazole Complex 635 (AM635) in a Chitosan Gel

Materials

The following materials were used in the examples and methods below:
1. Chitosan Powder, ≥95% deacetylation
2. Lactic Acid, 85%, CAS #50-21-5
3. Glycerol, 99%+, CAS #56-81-5
4. DiH₂O, CAS #7732-18-5

A chitosan gel was prepared by combining 20 g of deacetylated chitosan powder, 100 g of glycerol, and 860 g of deionized (DiH₂O) into a bottle. The solution is then mixed until the chitosan powder is dispersed. Then 20 g of lactic acid was added to the solution while slowly stirring until a thick, clear gel of 2% chitosan was formed.

1% volume-to-volume (v/v) of the AM635 solution (as prepared in Example 1) was added to the 2% chitosan gel and mixed together by vortexing or shaking into a rose-tinted gel product. This product is UV-sensitive as was store in either an opaque or amber bottle to prevent the silver ions from reducing back to zero-valence metallic Ag.

### Example 3. Preparation of Silver 1-Methylimidazole Complex 635 (AM635) Disinfectant Spray in Borax

Materials

The following materials were used in the examples and methods below:
1. Disodium Tetraborate Decahydrate (“Borax”) Na₂B₄*10H₂O, CAS #1303-96-4
2. DiH2O, CAS #7732-18-5
3. Silver 1-Methyl imidazole Complex, CAS #-na-

A disinfectant spray was prepared by heating 98.665 g of deionized (DiH₂O) to about 30-50° C. 1.335 g of Borax was then added to the warmed water and stirred until the Borax is fully dissolved. Then 1 mL of the AM635 solution (as prepared in Example 1) was added to the Borax solution and mixed until homogenized.

### Example 4. Preparation of Silver 1-Methylimidazole Complex 635 (AM635) Disinfectant Spray in SDS

Materials

The following materials were used in the examples and methods below:
1. Sodium Dodecyl Sulfate (SDS), CAS #151-21-3
2. DiH2O, CAS #7732-18-5
3. Silver 1-Methyl imidazole Complex (AM635), CAS #-na-

A disinfectant spray was prepared by combining 980.0 g of deionized (DiH₂O) with 10 g of SDS powder and stirring the mixture until fully dissolved. Then, 10 mL of the AM635 solution (as prepared in Example 1) were added to the SDS solution and mixed until homogenized.

### Example 5. Lawn Spray Assay of Silver 1-Methylimidazole Complex 635 (AM635) Disinfectant Spray in SDS

The efficacy of 0.5-2% SDS solutions (in DiH₂O)+0.1-10% Silver 1-Methyl imidazole were tested by performing a lawn-spray assay. The Silver 1-Methylimidazole Complex 635 (AM635) disinfectant sprays in SDS were prepared as described in Example 4. Briefly, a lawn of bacteria/yeast from a newly grown broth culture were inoculated onto their preferred agar media by dipping a swab into each broth, fully wetting the swab end, then swiping the swab back-and-forth from the top to the bottom of the plate, then turning the plate for a ¼ turn and re-streaking from top to bottom again. This technique ensures for total coverage of the inoculating bacteria/yeast across the face of the agar media. The dish was then opened and a paper towel placed over the top of the plate to cover only half of the surface while not touching the agar surface, so that the other half is exposed to the air. This exposed half was then treated with 2-pumps from a spray bottle containing the AM635 in SDS composition, ensuring that the exposed half of the plate was saturated by the test product. Each plate was treated using the same 2-pump criteria. All plates were then incubated “agar-down” overnight at 37° C. to allow the bacteria to fully grow (at 30° C. for yeast). For this test, a positive result indicates the treated half was free of microorganism growth, while the control side presented a full grown lawn of microorganisms. The microorganisms tested were:
1) Escherichia coli (Gram (−) bacteria), ATCC-25922
2) Klebsiella pneumonia (Gram (−) bacteria), ATCC-4352
3) Canadida albicans (yeast), ATCC-10231
4) Pseudomonas aeruginosa (Gram (−) bacteria), ATCC-9027
5) Staphylococcus aureus (Gram (+) bacteria), ATCC-6538

The effect of the 1% AM635 disinfectant solution was compared to 1% SDS solution (soap), 70% ethanol solution, and 10% bleach solution. The results indicated that the areas treated with the AM635 composition were entirely clear of any bacterial growth. Additionally, the SDS appeared to have a hypermigration effect such that the portions of the untreated area were also clear of bacterial growth.

### Example 6. Preparation of Silver 1-Methylimidazole Complex 635 (AM635) Hand Sanitizing Solutions

Materials

The following materials were used in the examples and methods below:
1. DiH2O, CAS #7732-18-5
2. Glycerol, CAS #56-81-5
3. Sodium Dodecyl Sulfate (SDS), CAS #151-21-3
4. Silver 1-Methyl imidazole Complex 635 (AM635), CAS #-na-
5. Aloe Vera Extract powder

An alcohol-free hand sanitizer 1.0% AM635 in 1.0% SDS (NBC-7009/AM0011) was prepared by mixing the materials to achieve a final formulation of:

| Ingredient | Weight % |
|---|---|
| Deionized Water | 93.87 |
| SDS | 1.0 |
| Glycerol | 5.0 |
| Aloe Vera Powder | 2.0 |
| AM635 | 1.0 |

A second alcohol-free hand sanitizer 1.0% AM635 in 0.75% SDS (NBC-7019/AM0019) was prepared by mixing the materials to achieve a final formulation of:

| Ingredient | Weight % |
|---|---|
| Deionized Water | 90.25 |
| SDS | 0.75 |
| Glycerol | 5.0 |
| Aloe Vera Powder | 2.0 |
| Borax | 1.0 |
| AM635 | 1.0 |

### Example 7. Lawn Spray Assay of Hand Sanitizers NBC-7009 and NBC-7019

The efficacy of the two hand sanitizing compositions was tested. NBC-7009 (AM0011) and NBC-7019 (AM0019) were prepared as described in Example 6. Briefly, a lawn of bacteria/yeast from a newly grown broth culture were inoculated onto their preferred agar media by dipping a swab into each broth, fully wetting the swab end, then swiping the swab back-and-forth from the top to the bottom of the plate, then turning the plate for a ¼ turn and re-streaking from top to bottom again. This technique ensures for total coverage of the inoculating bacteria/yeast across the face of the agar media. The dish was then opened and a paper towel placed over the top of the plate to cover only half of the surface while not touching the agar surface, so that the other half is exposed to the air. This exposed half was then treated with 2-pumps from a spray bottle containing the AM635 in SDS composition, ensuring that the exposed half of the plate was saturated by the test product. Each plate was treated using the same 2-pump criteria. All plates were then incubated “agar-down” overnight at 37° C. to allow the bacteria to fully grow (at 30° C. for yeast). For this test, a positive result indicates the treated half was free of microorganism growth, while the control side presented a full grown lawn of microorganisms. The microorganisms tested were:
1) Escherichia coli, Gram (−), ATCC-25922
2) Staphylococcus aureus, Gram (+), ATCC-6538
3) Pseudomonas aeruginosa, Gram (−), ATCC-9027
4) Klebsiella pneumonia, Gram (−), ATCC-4352
5) Canadida albicans (yeast), ATCC-10231

The results indicated that the treated areas were entirely clear of any bacterial growth.

### Example 8. Antimicrobial Activity Using a Time-Kill Procedure for Hand Sanitizers NBC-7009 (AM0011) and NBC-7019 (AM0019)

The efficacy of the two hand sanitizing compositions was tested. NBC-7009 (AM0011) and NBC-7019 (AM0019) were prepared as described in Example 6. The compositions were assessed for antimicrobial activity using the ASTM Assessment of Antimicrobial Activity Using a Time-Kill Procedure. Briefly, 5 mL sample sizes of the control or AM0011 or AM0019 hand santiizers were brought into contact with 50 μL of a 1/10 dilution of the new stock E. coli culture in tryptic soy broth (spike challenge organism). The activity of the test material was quenched at specified sampling intervals (for example, 30 s, 60 s with an appropriate neutralization technique. The test material was neutralized at the sampling time and the surviving microorganisms enumerated. The percent or log 10 reduction, or both, from either an initial microbial population, or test blank was calculated.

The results are provided in TABLES 1-7. Treatment with AM0011 showed greater than 6 Log reduction of E. coli in 2 minutes.

TABLE 1

| | | | | 5 ml Test | Total | | Primary |
|---|---|---|---|---|---|---|---|
| | | | | Soln | Spike | 1/10 Diln | Culture |
| Sample: | Plate: | cfu: | cfu/ml | cfu/ml | cfu/ 50 ul | cfu/ml | cfu/ml |
| (−) Control | 0 | 1.66E+04 | 1.66E+05 | 1.66E+06 | 8.30E+06 | 1.66E+08 | 1.66E+09 |
| Time: | 1 | 1.66E+03 | 16600 | | | | |
| | 2 | 166 | 1660 | | | | |
| | 3 | 16 | 160 | | | | |

TABLE 2

| | | | | 5 ml Test |
|---|---|---|---|---|
| | | | | Soln |
| Sample: | Plate: | cfu: | cfu/ml | cfu/ml |
| AM0011 | 0 | 1.18E+04 | 1.18E+05 | 1.18E+06 |
| Time: | 1 | 1180 | 11800 | |
| 0.5 min | 2 | 118 | 1180 | |
| | 3 | 12 | 120 | |

Log Reduction: 0.148226

TABLE 3

| | | | | 5 ml Test |
|---|---|---|---|---|
| | | | | Soln |
| Sample: | Plate: | cfu: | cfu/ml | cfu/ml |
| AM0011 | 0 | 1.05E+03 | 1.05E+04 | 1.05E+05 |
| Time: | 1 | 999 | 9990 | |
| 1 min | 2 | 99 | 990 | |
| | 3 | 9 | 90 | |

Log Reduction: 1.199333

TABLE 4

| | | | | 5 ml Test |
|---|---|---|---|---|
| | | | | Soln |
| Sample: | Plate: | cfu: | cfu/ml | cfu/ml |
| AM0011 | 0 | 0.00E+00 | 0.00E+00 | 1.00E+00 |
| Time: | 1 | 0 | 0 | |
| 2 min | 2 | 0 | 0 | |
| | 3 | 0 | 0 | |

Log Reduction: 6.220108

TABLE 5

| | | | | 5 ml Test |
|---|---|---|---|---|
| | | | | Soln |
| Sample: | Plate: | cfu: | cfu/ml | cfu/ml |
| AM0019 | 0 | 9.88E+03 | 9.88E+04 | 9.88E+05 |
| Time: | 1 | 988 | 9880 | |
| 0.5 min | 2 | 120 | 1200 | |
| | 3 | 12 | 120 | |

Log Reduction: 0.225351

TABLE 6

| | | | | 5 ml Test |
|---|---|---|---|---|
| | | | | Soln |
| Sample: | Plate: | cfu: | cfu/ml | cfu/ml |
| AM0019 | 0 | 5.10E+03 | 5.10E+04 | 5.10E+05 |
| Time: | 1 | 510 | 5100 | |
| 1 min | 2 | 51 | 510 | |
| | 3 | 4 | 40 | |

Log Reduction: 0.512538

TABLE 7

| | | | | 5ml Test |
|---|---|---|---|---|
| | | | | Soln |
| Sample: | Plate: | cfu: | cfu/ml | cfu/ml |
| AM0019 | 0 | 0.00E+00 | 0.00E+00 | 1.00E+00 |
| Time: | 1 | 0 | 0 | |
| 2 min | 2 | 0 | 0 | |
| | 3 | 0 | 0 | |

Log Reduction: 6.220108

Illustrations of Suitable Compositions and Methods

Illustration A1 is an antimicrobial composition comprising silver particles.

Illustration A2 is the composition of any preceding or subsequent illustration, wherein the silver particle is a silver salt.

Illustration A3 is the composition of any preceding or subsequent illustration, wherein the silver salt is a silver nitrate.

Illustration A4 is the composition of any preceding or subsequent illustration, wherein the amount of silver is between 0.5 to 10 wt. %.

Illustration A5 is the composition of any preceding or subsequent illustration, further comprising 1-methylimidazole.

Illustration A6 is the composition of any preceding or subsequent illustration, comprising at least one of:
(i) an alcohol
(ii) water
(iii) lactic acid
(iv) acetic acid
(v) polypropylene
(vi) glycerol
(vii) chitosan
(viii) glycerine
(ix) tetrasodium ethylenediaminetetraacetic acid EDTA
(x) fragrance
(xi) chamomile
(xii) aloe vera
(xiii) any combination of (i)-(xii).

Illustration A7 is the composition of any preceding or subsequent illustration, wherein the composition further comprises a carrier gel comprising a chitosan.

Illustration A8 is the composition of any preceding or subsequent illustration, wherein the composition comprises from about 0.5% to 5% by weight of chitosan powder.

Illustration A9 is the composition of any preceding or subsequent illustration, wherein the composition further comprises disodium tetraborate decahydrate.

Illustration A10 is the composition of any preceding or subsequent illustration, wherein the composition further comprises sodium dodecyl sulfate.

Illustration A11 is the composition of any preceding or subsequent illustration, wherein the composition is a liquid, an aerosol, a powder, a cream, a gel, or a lotion.

Illustration B1 is an article of manufacture of any one of illustrations A1-A11.

Illustration B2 is the article of manufacture of any preceding or subsequent illustrations, wherein the article of manufacture is one of a a liquid, an aerosol, a powder, a cream, a gel, or a lotion.

Illustration C1 is a method of using the composition of any one of illustrations A1-A11 to disinfect or sanitize a surface comprising applying the composition to a surface in the environment.

Illustration C2 is the method of any preceding or subsequent illustrations, wherein the surface is a part of a living being or an inanimate object.

Illustration D1 is a method for treating or preventing infection in a subject comprising topically administering to a subject the composition of any one of claims 1-11.

Illustration E1 is a method of making an antimicrobial composition comprising combining silver particles with at least one carrier.

Illustration E2 is the method of any preceding or subsequent illustrations, wherein the carrier comprises one of an alcohol, water, acid, polypropylene, glycerol, chitosan, glycerine, tetrasodium ethylenediaminetetraacetic acid (EDTA), fragrance, chamomile, aloe vera, or any combination thereof.

Illustration E3 is the method of any preceding or subsequent illustrations, wherein the silver particle is a silver salt.

Illustration E4 is the method of any preceding or subsequent illustrations, wherein the silver salt is a silver nitrate.

Illustration E5 is the method of any preceding or subsequent illustrations, wherein the amount of silver is between 0.5 to 10 wt. %.

Illustration E6 is the method of any preceding or subsequent illustrations, further comprising adding 1-methylimidazole.

Illustration E7 is the method of any preceding or subsequent illustrations, wherein the composition is a liquid, an aerosol, a powder, a cream, a gel, or a lotion.

1. An antimicrobial composition comprising silver particles.

2. The composition of claim 1, wherein the silver particle is a silver salt.

3. The composition of claim 1, wherein the silver salt is a silver nitrate.

4. The composition of claim 1, wherein the amount of silver is between 0.5 to 10 wt. %.

5. The composition of claim 1, further comprising 1-methylimidazole.

6. The composition of claim 1 comprising at least one of:
(i) an alcohol
(ii) water
(iii) lactic acid
(iv) acetic acid
(v) polypropylene
(vi) glycerol
(vii) chitosan
(viii) glycerine
(ix) tetrasodium ethylenediaminetetraacetic acid EDTA
(x) fragrance
(xi) chamomile
(xii) aloe vera; or
(xiii) any combination of (i)-(xii).

7. The composition of claim 1, wherein the composition further comprises a carrier gel comprising a chitosan.

8. The composition of claim 7, wherein the composition comprises from about 0.5% to 5% by weight of chitosan powder.

9. The composition of claim 1, wherein the composition further comprises disodium tetraborate decahydrate.

10. The composition of claim 1, wherein the composition further comprises sodium dodecyl sulfate.

11. The composition of claim 1, wherein the composition is a liquid, an aerosol, a powder, a cream, a gel, or a lotion.

12. An article of manufacture comprising an antimicrobial composition comprising silver particles.

13. A method of using a composition comprising an antimicrobial composition comprising silver particles to disinfect or sanitize a surface comprising applying the composition to a surface in the environment.

14. The method of claim 13, wherein the surface is a part of a living being or an inanimate object.

15. A method for treating or preventing infection in a subject comprising topically administering to a subject an antimicrobial composition comprising silver particles.

16. A method of making an antimicrobial composition comprising combining silver particles with at least one carrier.

17. The method of claim 16, wherein the carrier comprises one of an alcohol, water, acid, polypropylene, glycerol, chitosan, glycerine, tetrasodium ethylenediaminetetraacetic acid (EDTA), fragrance, chamomile, aloe vera, or any combination thereof.

18. The method of claim 16, wherein the silver particle is a silver salt.

19. The method of claim 18, wherein the silver salt is a silver nitrate.

20. The method of claim 16, wherein the amount of silver is between 0.5 to 10 wt. %.

21. The method of claim 16, further comprising adding 1-methylimidazole.

22. The method of claim 16, wherein the composition is a liquid, an aerosol, a powder, a cream, a gel, or a lotion.
